(19) United States
(12) Patent Application Publication
(10) Pub. No.: US 2026/0005566 A1
(43) Pub. Date: Jan. 1, 2026

(54) ROTOR ASSEMBLY FOR AN ELECTRIC PUMP DEVICE

(71) Applicant: MAHLE International GmbH, Stuttgart (DE)

(72) Inventors: Andraz Velikonja, Ajdovšcina (SI); Andrej Krusic, Šempeter pri Gorici (SI); Luka Cej, Solkan (SI)

(21) Appl. No.: 19/256,030

(22) Filed: Jun. 30, 2025

(30) Foreign Application Priority Data
Jul. 1, 2024 (DE) 102024118606.2

(51) Int. Cl. H02K 1/28; F04D 25/06; H02K 1/274; H02K 7/00

(52) U.S. Cl. CPC H02K 1/28; H02K 1/274; H02K 7/003; F04D 25/06

(57) ABSTRACT

A rotor assembly for an electric drive device includes a shaft with a fixing area, a rotor part secured by a plastic section, and first and second fixing projections spaced by a recess. The projections engage behind the plastic section to secure the rotor part. The fixing area includes intersecting right-handed and left-handed helical grooves that define the fixing projections.

### CROSS REFERENCE TO RELATED APPLICATION

This application claims priority to German Patent Application No. 102024118606.2, filed on Jul. 1, 2024, the contents of which is hereby incorporated by reference in its entirety.

### TECHNICAL FIELD

The invention relates to a rotor assembly for an electric drive device, in particular for an electric pump device of a motor vehicle, a shaft for the rotor assembly, and a method for manufacturing the shaft and a method for manufacturing the rotor assembly. In addition, the invention relates to an electric machine comprising the rotor assembly and an electric pump device comprising the rotor assembly.

### BACKGROUND

The state of the art includes a plurality of different electric motors as electric drive devices which, for example, are cooled during operation by fluid flowing around or through them. Such a drive device is described, for example, in EP4145683 B1. Electric motors are designed as so-called wet runners, particularly for use in pump devices, where some of their components are in direct contact with a fluid. For example, DE 102017203736 A1 describes an electric motor that is suitable, for example, for an electric pump device in a motor vehicle, wherein a permanent magnet rotor part of the electric motor is fixed in position on the hollow shaft by means of a rotor receiving sleeve, which is injection molded, for example, onto the hollow shaft and in which the rotor part is arranged. This provides a simple rotor assembly for an electric motor, for example for use in a pump device or fluid pump, with a drive rotor that rotates together with the shaft and can interact magnetically with a drive stator of an electric motor to generate torque that can be transmitted via the shaft.

### SUMMARY

One challenge in manufacturing rotor assemblies of this kind is ensuring that the respective plastic section, and thus the drive rotor or rotor part, is fixed in position on the shaft and remains reliable over the long term. In the prior art, this problem is solved by providing a fixing area on the shaft which has fixing projections that are gripped by the plastic section when the shaft is overmolded, so that the rotor part is fixed in position on the shaft by a form fit. For example, KR10-2006-0133865 discloses providing a fixing area on the shaft by knurling its surface. This prevents slipping on the shaft.

However, it has been found that the introduction of such knurling on comparatively fragile shafts can cause undesirable damage, in particular deformation. Such damage leads at least to dimensional inaccuracies, which impair the concentricity of the rotor assembly, for example. In addition, special tools are required to apply this type of knurling, which makes production costly.

One task of the present invention is therefore to provide a rotor assembly in which at least one of the aforementioned disadvantages is at least partially improved. In particular, one task of the invention is to provide a simple and reliable fixation to the shaft, the provision of which avoids overstressing the shaft.

The task is solved according to one aspect of the invention by a rotor assembly with features according to claim 1. Advantageous embodiments are described in the respective subclaims.

According to a particularly simple embodiment, the task is already solved by providing a rotor assembly whose shaft is provided with at least two helical grooves, in particular thread threads, which intersect each other while providing fixing projections between them.

The rotor assembly according to the invention comprises a shaft, a rotor part fixed in position at the fixing area, and a plastic section. The shaft has a fixing area where the rotor part is fixed to the shaft. The fixing area has at least a first fixing projection and a second fixing projection. In particular, the fixing area has a plurality of fixing projections. The fixing projections, i.e., at least the first and second fixing projections, are each spaced apart from one another by a fixing recess. The fixing projections engage behind the plastic section in such a way that the rotor part is fixed in position on the shaft, in particular in such a way that the rotor part cannot be removed from the shaft without destruction, in particular without destruction of at least the plastic section. In particular, the fixing projections are embedded in the plastic material of the plastic section. Due to the fixed position, the plastic section can only be moved and/or rotated relative to the shaft to a limited extent and, in particular, to a negligible degree. According to the invention, the fixing area is provided with at least a first helical groove and a second helical groove. According to the invention, the first helical groove cuts the second helical groove while providing the fixing projections. In particular, the first helical groove is designed to be right-handed and the second helical groove is designed to be left-handed. However, the invention also includes special embodiments in which the helical grooves intersect due to a suitable choice of the respective pitch. In general, it is preferred that the first helical groove is provided by a first thread, which is designed in particular as a right-hand thread, and/or that the second helical groove is provided by a second thread, which is designed in particular as a left-hand thread.

It is particularly preferred that the fixing region of at least one axial end, in particular both axial ends, of the shaft is axially spaced apart. In particular, the fixing area is offset. This means that the fixing area is preferably further spaced from one axial end of the shaft than from the other axial end of the shaft. In particular, the distance between the fixing area and at least one of the axial ends of the shaft is at least 25%, in particular at least 30%, and in particular a maximum of 50% of the axial extension of the shaft. This allows the respective end of the shaft to be designed in accordance with the application, for example to provide a bearing surface for mounting the shaft. The axial extension of the shaft is the extension perpendicular to the direction in which the shaft has its smallest extension. In particular, the first fixing projection and the second fixing projection are arranged so as to overlap axially, wherein in particular the two fixing projections are spaced apart from each other along the circumference by the fixing recess.

In general, it is preferable for the fixing recess to be formed by the first and/or second helical groove. Once the helical grooves have been provided by the first thread and the second thread, the fixing recess is preferably formed by a thread pitch of the first and/or second thread. Thus, the fixing projections are preferably produced by inserting the threads while forming the fixing recess. According to one embodiment, the first thread is designed as a single-start thread. According to one embodiment, the second thread is designed as a single-start thread. According to one embodiment, at least one of the threads is designed as a multi-start thread.

According to one embodiment, at least the first helical groove and/or the second helical groove has a variable pitch. According to a particularly preferred embodiment, the first helical groove and/or the second helical groove has a constant pitch. A constant pitch makes it easier to produce the helical grooves. In general, the first helical groove should have a pitch of at least 0.5 mm. According to a generally preferred embodiment, the second helical groove has a pitch of at least 0.5 mm. It has been found that, starting at this angle of inclination, fixing projections can be produced that enable an improved fixing position.

The fixing recess preferably comprises a section of the base, i.e., the groove bottom, the first helical groove, and/or the second helical groove. In particular, the fixing recess comprises the thread base of the first thread and/or the second thread. In particular, a transition from the fixing recess to the respective fixing projection is formed by a groove wall section of the first helical groove and/or a groove wall section of the second helical groove, in particular by a respective thread flank of the first thread and/or second thread. Preferably, the respective fixing projection comprises a section of the thread tip of one of the threads. In a particularly preferred embodiment, the first fixing projection comprises a section of the thread tip of the first thread, wherein the second fixing projection comprises a section of the thread tip of the second thread. Various thread shapes can be considered for the threads. For example, the first thread and/or the second thread may each be a thread form selected from a group comprising flat threads, round threads, saw threads, pointed threads, trapezoidal threads, and Whitworth threads.

The rotor part generally comprises a plurality of permanent magnets distributed along a circumference. In advantageous embodiments, the permanent magnets are arranged as a Halbach array. In a Halbach array, the permanent magnets are arranged in a spatially rotating magnetization pattern. In such embodiments, a rotor core can be dispensed with. In preferred embodiments, however, the rotor part comprises a rotor core. The rotor core can be designed as a solid body in some embodiments. In particularly preferred embodiments, however, the rotor core comprises a plurality of metal sheet sections stacked on top of one another. The metal sheet sections are joined together to form a stack of metal sheets, also known as a lamella stack. The metal sheet sections or the stack of metal sheets extend around the shaft. Preferably, several of the plurality of metal sheet sections have retaining sections distributed along the circumference of the rotor core. The permanent magnet rotor core is particularly preferred. In particular, the permanent magnets are distributed along the circumference and held in place at the retaining sections. In particular, the permanent magnets, preferably form-fitting, are attached to at least several of the metal sheet sections by means of the retaining sections, each relative to a radial direction and/or an axial direction. In particular, the permanent magnets are enclosed, at least in some areas, by plastic from the plastic section. This provides additional positional stability, especially without the need to glue in permanent magnets. In general, it is advantageous for the rotor core to have recesses on the front side into which the plastic section protrudes. This enables further improved fixation of the rotor core in or on the plastic section. In particular, the plastic section surrounds the metal sheet sections and the permanent magnets, at least in sections.

The retaining sections are preferably designed as pockets in the rotor core, in particular in the metal sheet stack, with the permanent magnets inserted into the pockets. In particular, the pockets are arranged such that the permanent magnets are spaced apart from a radial outer side of the rotor core, in particular by at least 5% of a radial extension of the rotor core between two radially opposite ends of the rotor core. Preferably, the pockets are open toward one side in the axial direction, especially toward one end face, especially toward the same end face, of the rotor core, which can make it easier to insert the permanent magnets. This makes it possible to produce the metal sheet sections with a simple contour, which enables the permanent magnets to be held particularly securely by the retaining sections.

According to one embodiment, the rotor part is radially spaced from the shaft, in particular at least by a region of the plastic section, in particular over its entire length. According to one embodiment, the rotor part, in particular the rotor core, is located in some areas directly on the shaft.

The plastic section is generally advantageously produced by overmolding the shaft and/or rotor part. In particular, the plastic section surrounds the rotor part at least radially and on one axial side of the rotor part. The plastic section is to be understood as a single-piece, integral element, the contour of which is preferably defined at least in part by the contour of the shaft and the rotor part. Preferably, the plastic section comprises at least one thermoset and/or one thermoplastic as plastic material. The plastic section preferably comprises polyphenylene sulfide (PPS) as the plastic material. Such a material is particularly preferred for improved accuracy and robustness. According to one embodiment, the plastic section is connected, in particular in a fluid-tight manner, to a rotor cover section which at least partially closes off an end face of the rotor part. In particular, the plastic section is welded to the rotor cover section to form a fluid-tight connection, in particular by ultrasonic welding and/or friction welding. Rotary welding is the preferred method of friction welding. It is particularly preferred that the rotor cover section is arranged on an end face of the rotor part pointing away from the slide bearing.

It was unexpectedly discovered that the provision of intersecting helical grooves as described above already ensures reliable fixation of the rotor part to the shaft via the plastic section. At the same time, this type of fastening eliminates the need for knurling or similar measures to structure the outer surface of the shaft. This reduces stress on the shaft during manufacture of the fixing area, particularly with regard to radial stress. Instead of deforming the shaft material in the radial direction, material is gently removed and/or moved in the axial direction to provide the fixing projections. It has also been found that the provision of threads enables particularly reliable rear engagement of the plastic section and the fixing area. The helical grooves allow the creation of fixing projections which provide greater radial extension and, depending on the pitch of the helical grooves, improved fixation against axial forces and/or torques. In addition, simple tools can be used to manufacture the rotor assembly. In particular, knurling tools are not required during manufacture.

The rotor assembly according to the invention is particularly suitable for an electric pump device. The electric pump device is particularly preferred as a fluid pump for liquids such as oil, water, glycol, or the like. For example, the pump device may be a lubricant pump for conveying lubricants such as oil or the like. For example, the pump device may be a coolant pump for conveying coolant, such as water, glycol, and/or mixtures thereof.

According to an advantageous embodiment, the shaft is designed as a hollow shaft at least in sections, in particular over its entire axial extension. The shaft, which is therefore at least partially tubular, has a shaft passage that provides a cavity in the shaft. The shaft passage extends uninterrupted across the fixing area, in particular across the entire axial extension of the shaft.

When designing the shaft as a hollow shaft, it is particularly advantageous to provide fixing projections by means of helical grooves, since hollow shafts can only withstand low radial forces compared to solid shafts without permanently deforming. This ensures greater dimensional accuracy in designs with hollow shafts.

According to a preferred embodiment, the hollow shaft has a first wall thickness radially between the shaft passage and one of the fixing projections and a second wall thickness radially between the shaft passage and the fixing recess. The second wall thickness is a maximum of 70%, in particular a maximum of 50%, in particular a maximum of 35%, of the first wall thickness. In particular, the first wall thickness and the second wall thickness are axially at the same height. Thus, the wall thickness varies, in particular along the circumference of the hollow shaft, at least between the first wall thickness and the second wall thickness. In particular, the first wall thickness is measured between the shaft passage and an area between the first helical groove and the second helical groove, in particular the thread tip of the first and/or second thread. In particular, the second wall thickness is measured between the shaft passage and the bottom of the first helical groove and/or the second helical groove, in particular the thread base of the first and/or second thread. In particular, the maximum groove depth of the first helical groove and/or the second helical groove is no more than two-thirds of a third wall thickness of the hollow shaft outside the fixing area. If the respective helical groove is provided by one of the threads, the maximum groove depth is, in particular, the maximum thread depth of the first thread and/or the second thread, i.e., a radial distance between the thread tip and the thread base, is at most two-thirds of a third wall thickness of the hollow shaft outside the fixing area. In particular, the shaft is designed such that it has a constant wall thickness and/or a constant outer diameter over at least 80% of its axial length before the first and second helical grooves are formed.

By providing the hollow shaft with different wall thicknesses, material can be saved and a compact design is made possible. This contributes, for example, to weight savings in the rotor assembly. It was unexpectedly found that even with the wall thickness ratios described above, sufficient dimensional stability of the shaft can be ensured. This minimizes manufacturing errors.

According to a generally advantageous embodiment, the fixing projections are produced by machining. In particular, the fixing projections are produced at least by cutting the first helical groove, in particular the first thread. In particular, the fixing projections are produced at least by cutting the second helical groove, in particular the second thread. In particular, the shaft has a constant outer diameter over at least 80% of the axial length of the shaft before cutting the respective helical groove.

By machining the fixing projections, material deformation radially inward is largely avoided, which ensures that functionally relevant dimensions of the shaft are not changed when the fixing projections are inserted. This eliminates the need for post-processing steps. This can be particularly advantageous in the case of thin-walled hollow shafts, where conventional methods of producing the fixing projections can lead to undesirable production-related changes to the inner contour, for example by the tool contour used for production marking the inside.

A further improvement can be achieved by suitably selecting the respective flank angle of the first helical groove and/or the second helical groove, in particular of the first thread and/or the second thread. According to an advantageous embodiment, the fixing projections are radially tapered. In particular, a respective cross-section of the respective fixing projection pointing in the radial direction decreases along the course in the radial direction, in particular by at least 20%, in particular by at least 50%. Preferably, the respective fixing projections are tapered in such a way that an angle is formed between a first fixing wall surface of the first fixing projection and a second fixing wall surface of the second fixing projection, wherein the angle is between 25° and 85°, in particular between 35° and 55°, in particular at least 45°. This prevents play and improves the force transmission between the plastic section and the shaft, thereby securing the rotor part in place. The second fixing wall surface faces the first fixing wall surface. The fixing wall surfaces therefore face each other. In relation to the respective helical groove, in particular the respective thread, this preferably results in a respective flank angle that corresponds to the angle described above.

According to a preferred embodiment, the first helical groove and/or the second helical groove each extend over more than 50%, in particular at least 70%, in particular at least 85%, in particular over 100%, of the axial extension of the fixing area. This maximizes the area in which the plastic section and shaft engage behind each other to secure the rotor part. In particular, the first helical groove overlaps axially with at least 60%, in particular at least 85%, in particular at least 95%, of the second helical groove. By providing as large an overlap area as possible, the number of fixing projections with which the plastic section can engage behind can be maximized.

Preferably, the fixing area comprises at least two thread pitches, provided that the helical grooves are provided by threads. The at least two thread pitches are formed by the first thread and the second thread. The first thread thus preferably has a first thread pitch of the thread pitches, wherein the second thread has a first thread pitch of the thread pitches. Preferably, the thread pitches extend from one end of the fixing area, in particular from the same end of the fixing area. In general, the first thread has a thread pitch of at least 0.5 mm. According to a general embodiment, the second thread has a thread pitch of at least 0.5 mm. It has been found that, starting at this thread pitch, fixing projections can be created that enable improved positional stability.

According to an advantageous embodiment, the rotor assembly comprises at least one slide bearing, preferably designed as an axial bearing. In particular, the slide bearing comprises an axial bearing section and a radial bearing section. The slide bearing is fixed in position relative to the shaft and the rotor part by means of the plastic section, in particular by overmolding the slide bearing. This eliminates the need for separate bearings that would otherwise have to be attached to the drive rotor. The slide bearing is preferably designed in one piece and comprises a first bearing section, which has a front slide bearing surface, and a second bearing section, which forms a bearing flange and is embedded in the plastic of the plastic section, in particular completely. The slide bearing is designed to bear against a corresponding slide bearing surface of a corresponding slide bearing section during operation. In particular, the slide bearing surface is designed to be lubricated by fluid that can be conveyed by the rotor assembly. This reduces friction-related resistance between the slide bearing surfaces during operation. In particular, the first bearing section extends axially beyond the plastic section. This ensures reliable operation of the system on the slide bearing surface. It is preferable for the slide bearing to be positioned completely next to the rotor part in the axial direction. It is particularly preferred that the shaft extends axially through the slide bearing beyond the slide bearing. The slide bearing is advantageously made of ceramic and/or graphite, which enables advantageous sliding properties.

According to a generally advantageous embodiment, the first fixing projection and/or the second fixing projection are each diamond-shaped, in particular such that the respective fixing projection has several fixing wall surfaces, each of which forms an angle of less than 90° with the adjacent fixing wall surfaces of the same fixing projection. For example, the first fixing wall surface can form an angle of less than 90° with each adjacent fixing wall surface of the first fixing projection. For example, the second fixing wall surface can form an angle of less than 90° with each of the adjacent fixing wall surfaces of the second fixing projection. With this design of the fixing projections, which can be achieved in particular by suitable cutting of the first helical groove and the second helical groove, better load distribution can be achieved while ensuring reliable fixation, since any stresses in the circumferential direction can be deflected into axial loads.

According to a further aspect, the invention relates to a pump device which is advantageously designed as an electric pump device. The pump device is preferably suitable and/or intended for use in a motor vehicle. The pump device comprises a rotor assembly according to the invention, at least one pump rotor, which is designed to convey fluid, in particular lubricant and/or coolant, from an inlet of the pump device to an outlet of the pump device. The rotor assembly is designed as part of a drive device, in particular an electric drive device, for driving the pump rotor. In preferred embodiments, the rotor assembly may have features that are disclosed above in connection with the rotor assembly according to the invention. It is particularly preferred for the pump rotor to be attached to one axial end of the shaft. The rotor assembly of the pump device forms a drive rotor of the drive device. The pump rotor is connected to the shaft of the rotor assembly in a fixed position, with the shaft being mounted so that it can rotate about an axially extending axis of rotation between the pump rotor and the drive rotor. This makes it possible to provide a hydraulic area in which the pump rotor is arranged for conveying fluid, and an electrical area in which the drive rotor of the drive device is arranged for driving the pump rotor in the hydraulic area by means of the shaft.

The pump device can be designed, for example, as an impeller pump, a gerotor pump, or the like. In some versions of the impeller pump, the pump rotor is designed as an impeller. In some versions of the gerotor pump, the pump rotor is designed as an internal rotor or as an external rotor of the gerotor. The respective pump device is preferably designed for a hydraulic system, for a cooling system, and/or for a lubrication system, wherein such systems are also covered by the invention in accordance with a further aspect, insofar as they comprise a pump device according to the invention. For example, the pump device can be designed as an oil pump. For example, the pump device can be designed as a coolant pump.

According to a preferred embodiment, the pump device has a housing which encloses a pump area in which the pump rotor is arranged for conveying fluid from the inlet to the outlet, and a motor area in which the drive rotor is arranged for interacting with a drive stator of the drive device to generate a rotary movement of the pump rotor. In particular, the pump area and the motor area are separated axially from each other by an intermediate housing part, which advantageously provides at least one radial bearing and/or one axial bearing for the shaft. It is particularly preferred that the pump rotor and the drive rotor are mounted on the intermediate housing part via the shaft in the manner of a flying bearing. In particular, the intermediate housing part comprises a slide bearing surface corresponding to the slide bearing of the rotor assembly for axial bearing of the rotor assembly. In particular, the drive stator comprises several stator windings, wherein the stator windings are separated from the drive rotor in a fluid-tight manner. In particular, the drive stator and drive rotor are spaced apart radially by at least an annular gap, wherein the annular gap is designed to provide a channel for fluid from the pump chamber. This allows heat generated during operation of the pump device to be effectively dissipated by means of fluid to cool the pump device. In particular, the shaft of the rotor assembly, which provides the drive rotor of the drive device, is designed as a hollow shaft, with the shaft passage providing a fluid-carrying connection between the pump area and the motor area.

According to a further aspect, the invention relates to a shaft for a rotor assembly according to the invention. The rotor assembly is designed in particular for a pump device according to the invention, in which the rotor assembly can provide the drive rotor. According to the aspect of the invention, the shaft is designed as a hollow shaft, wherein the shaft has a fixing area at which a rotor part can be fixed in position by means of a plastic section, wherein the fixing area has at least a first fixing projection and a second fixing projection, which are designed to engage behind the plastic section for fixing the rotor part in position on the shaft. The fixing area is provided with at least one first helical groove and with a second helical groove. The first helical groove and the second helical groove cut into each other, providing the multiple fixing projections. The first and second fixing projections are spaced apart in particular by a fixing recess, wherein the fixing recess is preferably provided by a respective section of the base of the first helical groove and/or the second helical groove, in particular the thread base of the first thread and/or the second thread. The shaft may have features that are described above in connection with the rotor assembly and/or the pump device.

According to a further aspect, the invention comprises a rotor assembly for an electric drive device and a shaft designed as a hollow shaft for a molded drive rotor of an electric drive device. The hollow shaft may have features that are described above in connection with the shaft for the rotor assembly and/or the pump device. Furthermore, the overmolded drive rotor may have features that are described above in connection with the shaft for the rotor assembly, the rotor assembly, and/or the pump device.

According to one aspect, the invention also relates to a method for manufacturing a shaft according to the invention. The method comprises the method steps of providing a hollow shaft having a region designated as a fixing area, in which the hollow shaft has a constant outer diameter; providing the hollow shaft with a first helical groove to produce the fixing area, the first helical groove being right-handed; providing the hollow shaft with a second helical groove such that the first helical groove intersects the second helical groove, providing fixing projections in the fixing area, wherein, in particular, the second helical groove is a left-handed thread. In particular, the first helical groove and/or the second helical groove are cut into the hollow shaft. The method may include further features disclosed above in connection with the shaft according to the invention, the rotor assembly according to the invention, or the pump device according to the invention.

The invention also relates to a method for manufacturing the rotor assembly according to the invention. The method comprises providing a shaft according to the invention, in particular by performing the above-described method steps for manufacturing the shaft. The method further comprises providing a rotor part and positioning and pre-fixing it relative to the shaft in such a way that the rotor part surrounds the shaft along the circumference; and injection molding the rotor part and shaft with plastic material to produce a plastic section which engages behind the fixing projections of the fixing area of the shaft in such a way that the rotor part is fixed in position on the shaft. In particular, the rotor part and shaft are placed in a tool, especially an injection molding tool, to pre-fix the drive rotor relative to the shaft. In particular, the rotor assembly is removed from the mold in one piece after overmolding. The method and the components used in the method for the rotor assembly may each have features that are disclosed above in connection with the rotor assembly according to the invention.

According to one aspect, the invention also relates to an electric drive device, such as an electric motor, wherein the drive device has a drive stator comprising a plurality of stator windings, wherein the electric drive device further comprises a drive rotor, wherein the drive rotor is formed by a rotor assembly according to the invention, wherein the rotor part of the rotor assembly is arranged axially at the level of the drive stator and is surrounded by the drive stator along the circumference. The drive rotor is mounted by the shaft of the rotor assembly so that it can rotate about an axial axis of rotation relative to the drive stator. The drive device may have features that are disclosed above in connection with the rotor assembly according to the invention, the shaft according to the invention, the pump device according to the invention, or at least one of the methods according to the invention.

According to one aspect, the invention also relates to an electric machine. The electric machine is designed to generate torque for transmitting rotary motion to a drive shaft. The electric machine comprises an electric drive device according to the invention. According to one embodiment, the shaft of the rotor assembly is designed as the drive shaft. According to another embodiment, the shaft of the rotor assembly is coupled to the drive shaft via a gear of the electric machine, in particular a planetary gear.

Further details, advantages, and features of the invention can be seen in the following explanation of preferred exemplary embodiments with reference to the accompanying drawings, without limiting the generality of the foregoing description.

### BRIEF DESCRIPTION OF THE DRAWINGS

FIG. 1: As a schematic sketch, an example embodiment of a rotor assembly;

FIG. 2: As a sectional view, an exemplary embodiment of the rotor assembly according to the invention;

FIG. 3A and FIG. 3B: Various views of an exemplary embodiment of a shaft according to the invention;

FIG. 4: As a schematic sketch, two views of the structure of the shaft's fixing area; and

FIG. 5: In a schematic sectional view, a detail of an exemplary embodiment of a pump device according to the invention.

For better understanding, parts that are identical in the invention are designated with the same reference numerals.

### DETAILED DESCRIPTION

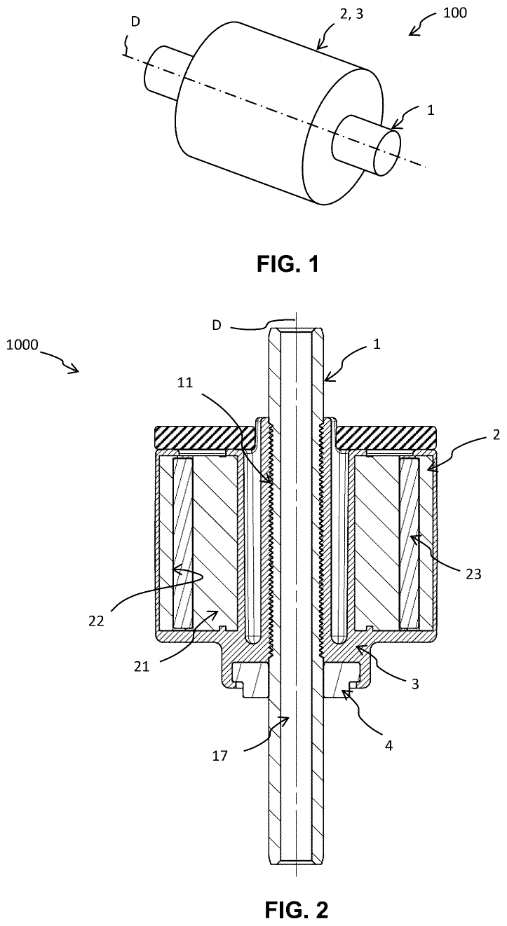

FIG. 1 shows a schematic sketch of an example embodiment of a rotor assembly 1000. The components of rotor assembly 1000 are relatively immovable in relation to each other. The rotor assembly 1000 comprises a shaft 1 and a component attached thereto, which comprises a rotor part 2 and a plastic section 3. The rotor part 2 is fixed in position on the shaft 1 by means of the plastic section 3. On both sides, the shaft 1 has end sections for rotatable mounting of the rotor assembly about an axis of rotation D. The rotor assembly is essentially rotationally symmetrical about the axis of rotation D.

FIG. 2 shows a longitudinal section of an exemplary embodiment of the rotor assembly 1000 according to the invention. The rotor assembly 1000 is suitable for a pump device according to FIG. 5. The rotor assembly 1000 comprises a shaft 1, which is designed as a hollow shaft and has a shaft passage 17 that extends axially without interruption beyond the fixing area 11 over the entire length of the shaft. The shaft 1 further has a fixing area 11 extending axially over approximately 50% of the shaft. The fixing area 11 has a plurality of fixing projections 12, 13 between fixing recesses 14, which are produced by the fact that the shaft 1 in the fixing area 11 is provided with two helical grooves 15, 16 in the form of a first and a second thread. The first helical groove 15 cuts into the second helical groove 16, so that no continuous groove wall or thread flank remains in the cut area, but rather defined fixing projections 12, 13 are provided. The fixing projections 12, 13 are thus spaced apart by the fixing recess 14. In this design, the threads cut into each other because they were cut into the shaft in opposite directions. This means that the first helical groove 15 is right-handed, i.e., designed as a right-hand thread, and the second helical groove 16 is left-handed, i.e., designed as a left-hand thread. Both helical grooves 15, 16 extend essentially across the entire fixing area 11 and have a pitch of approximately 0.5 mm.

A rotor core of the rotor part 2 of the rotor assembly 1000 is fixed in position at the fixing area 11. The rotor core is made up of a plurality of metal sheet sections 21 stacked on top of each other, which are not shown separately but rather as a block representing the stack of metal sheet sections 21. The metal sheet sections 21 have retaining sections 22 distributed along the circumference of the rotor part 2 in the form of pockets. Permanent magnets 23 are inserted into the retaining sections 22 so that the permanent magnets 23 are held along the circumference distributed at the retaining sections 22.

To secure the rotor part 2 to the shaft 1, the rotor part 2 is embedded in plastic material of a plastic section 3 of the rotor assembly 1000 in such a way that only an area on one end face remains open, which is sealed in a fluid-tight manner by a rotor cover section. The plastic section 3 is formed by overmolding the shaft and the rotor part 2. The plastic section 3 and fixing projections 12, 13 engage behind the shaft 1 in such a way that the rotor part 2 is fixed in position thereon. This results in a positive lock in relation to an axial direction along the axis of rotation D and in relation to a radial direction perpendicular to the axis of rotation D. The plastic section 3 and rotor part 2 are already securely fixed to each other by the overmolding of the rotor part 2. However, the rotor part, in particular the rotor core 2, may also advantageously have projections and/or recesses into which the plastic material can flow during overmolding to provide additional improved form closure.

Next to the fixing area 11, a slide bearing 4 designed as an axial bearing is mounted on the shaft. The slide bearing 4 is fixed relative to the shaft 1 and the rotor part 2 by means of the plastic section 3 by overmolding the slide bearing 4 with plastic material of the plastic section 3. The slide bearing 4 is designed as a single piece with a first bearing section, which has a front slide bearing surface, and a second bearing section, which forms a bearing flange and is embedded in the plastic material of the plastic section 3.

Radially between shaft 1 and rotor part 2, several pockets formed by the plastic section 3 extend axially along the circumference across the entire rotor part 2. This is generally advantageous in order to reduce any internal stresses in the area between shaft 1 and rotor part 2 and also serves to optimize weight. Furthermore, this ensures that sufficient plastic remains in the plastic section between the fixing projections so that the plastic section engages behind the fixing projections for secure fixing. This is because shrinkage during overmolding is reduced compared to a design without pockets.

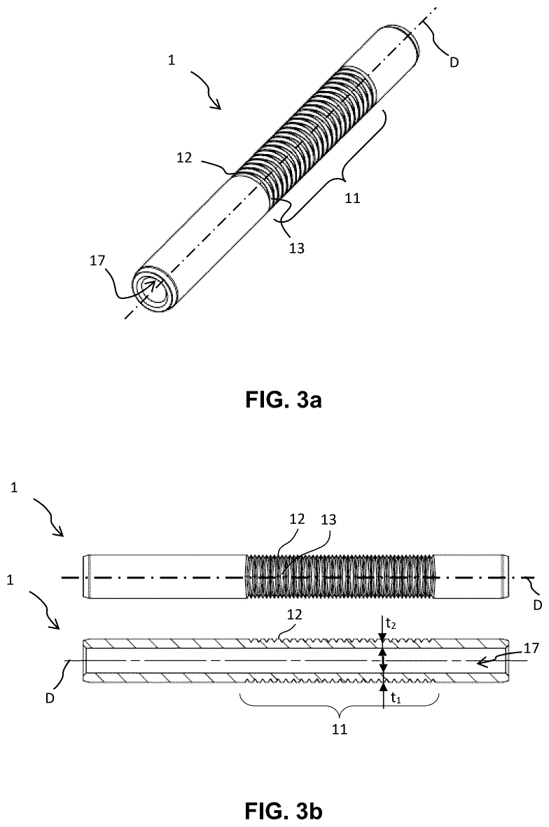

FIG. 3A and FIG. 3B show, in an oblique view, in a longitudinal view, and in a longitudinal section derived from the longitudinal view as a section along the axis of rotation D, an exemplary embodiment of a shaft 1 according to the invention, which is suitable for a rotor assembly 1000 described above in connection with FIG. 2. The hollow shaft 1 has a shaft passage 17 with a constant inner diameter that extends across the entire shaft. The end of shaft 1 is beveled for easy joining. The fixing area 11 extends centrally offset, across which the first helical groove 15 and the second helical groove 16 provide a plurality of fixing projections 12, 13 between fixing recesses 14, which each comprise a groove base of the first and second helical grooves 15, 16. The fixing area 11 is spaced axially from one end of the shaft 1 by approximately twice the distance from the other end of the shaft 1. The shaft 1 is produced by providing a hollow shaft having a fixing area 11, providing the hollow shaft in the fixing area with the first helical groove 15 as a first thread, providing the hollow shaft in the fixing area with a second helical groove 16 as a second thread, so that the first helical groove 15 intersects the second helical groove 16, providing fixing projections 12, 13 in the fixing area 11, wherein the first helical groove 15 and/or the second helical groove 16 are cut into the hollow shaft.

By providing the fixing projections 12, 13, two wall thicknesses t₁, t₂ of the hollow shaft can be determined at the same axial height, wherein one wall thickness t₂ is measured at the height of the respective groove bottom or fixing recess 14 and the other wall thickness t₁ is measured at the level of the respective fixing projection 12, 13 or the respective thread tip.

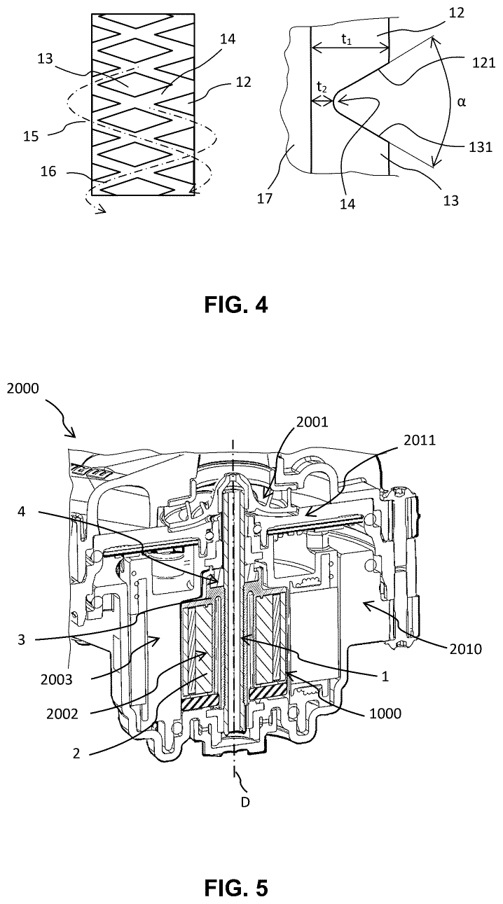

FIG. 4 shows a schematic sketch of two views of the structure of the fixing area of the shaft, in particular as shown in FIG. 3A and FIG. 3B. On the left side of FIG. 4, it can be seen that providing a left-hand thread and a right-hand thread as the first helical groove 15 and second helical groove 16 can result in the first fixing projection 12 and/or the second fixing projection 13 each being diamond-shaped, which is desirable in order to enable load transfer from the plastic section 2 to the shaft 1 in a manner adapted to the load. The respective fixing projection 12, 13 thus has several fixing wall surfaces, each of which forms an angle α of 90° with the adjacent fixing wall surfaces of the same fixing projection. In accordance with the contour of the respective thread type selected, the fixing projections 12, 13 are also designed to taper radially. An angle a is formed between adjacent fixing projections 12, 13 (see right-hand side of FIG. 4) between a first fixing wall surface 121 of the first fixing projection 12 and a second fixing wall surface 131 of the second fixing projection 13, which faces the first fixing wall surface 121. The fixing wall surfaces 121, 131 are angled. The angle α is between 25° and 85°. The hollow shaft also has special wall thickness ratios t₁ and t₂. The second wall thickness t₂ radially between shaft passage 17 and fixing recess 14 can, for example, be 35% of the first wall thickness t₁ radially between shaft passage 17 and one of the fixing projections 12, 13. A radial distance between the thread tip and thread base of the first helical groove and/or the second helical groove can, for example, be two-thirds of a third wall thickness of the hollow shaft outside the fixing area.

FIG. 5 shows a schematic cross-sectional view of a section of an exemplary embodiment of a pump device 2000 according to the invention. Areas of the electric pump device 2000 at the top and on the left side are shown broken away. The pump device 2000 is suitable for a motor vehicle and can be used, for example, as a coolant pump with coolant as the fluid. The pump device 2000 comprises a rotor assembly 1000 according to the embodiment described in connection with FIG. 2. The pump device has a pump rotor 2001 for conveying fluid from an inlet to an outlet of the pump device 2000, wherein the pump rotor 2001 is an impeller or impeller wheel. The rotor assembly 1000 is part of an electric drive device for driving the pump rotor 2001. The rotor assembly 1000 forms a drive rotor 2002 of the drive device, which is connected in a position-fixed manner to the shaft 1 of the rotor assembly. Wave 1 of rotor assembly 1000 is mounted on both sides of rotor core 2 so that it can rotate about an axially extending axis of rotation D.

The pump device further comprises a housing which encloses a pump area and a motor area. In the motor area, the drive rotor 2002 is arranged to interact with a drive stator 2003 of the drive device to generate a rotary motion of the pump rotor 2001. The pump rotor is located in the pump area 2001. The pump area is connected to the inlet and outlet accordingly. The pump area and motor area are separated by an intermediate housing part 2011, which provides a radial bearing for the shaft, which also has an axial bearing section for interaction with the slide bearing 4 of the rotor assembly 1000.

The drive stator 2003 has several stator windings (not shown) that are separated from the drive rotor 2002 in a fluid-tight manner. The fluid-tight separation is made possible by overmolding the drive stator 2003 and/or by providing a gap pot, gap tube, or the like. The drive stator 2003 and drive rotor 2002 are radially spaced apart by at least an annular gap, wherein the annular gap is designed to provide a channel for fluid from the pump chamber. The fluid can flow along a flow path that passes through the annular gap and through the shaft passage 17 of the shaft 1. This specifies a predefined path for fluid starting from the pump area. The fluid can also generally flow advantageously through a bearing gap between shaft 1 and the radial bearing of the intermediate housing part 2011 into the motor area to the annular gap.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A rotor assembly for an electric drive device, comprising:
a shaft including a fixing area;
a rotor part fixed in position at the fixing area; and
a plastic section through which the rotor part is fixed to the shaft,
wherein the fixing area comprises at least a first fixing projection and a second fixing projection, the first fixing projection spaced apart from the second fixing projection by a fixing recess,
wherein the first fixing projection and the second fixing projection engage behind the plastic section to secure the rotor part in the position on the shaft,
wherein the fixing area comprises a first helical groove and a second helical groove,
wherein the first helical groove intersects the second helical groove to provide the first and second fixing projections, and
wherein the first helical groove is a right-handed groove, and the second helical groove is a left-handed groove.

2. The rotor assembly according to claim 1, wherein the shaft is a hollow shaft having a shaft passage that extends axially without interruption through the fixing area.

3. The rotor assembly according to claim 2, wherein the hollow shaft comprises:
a first wall thickness extending radially between the shaft passage and one of the first and second fixing projections; and
a second wall thickness extending radially between the shaft passage and the fixing recess,
wherein the second wall thickness is at most 70% of the first wall thickness.

4. The rotor assembly according to claim 1, wherein:
the first and second fixing projections are produced by machining including cutting the first helical groove and/or the second helical groove, and
the hollow shaft has a substantially constant wall thickness prior to cutting the respective helical groove.

5. The rotor assembly according to claim 1, wherein:
the first and second fixing projections are radially tapered such that an angle is defined between a first fixing wall surface of the first fixing projection and a second fixing wall surface of the second fixing projection, the second fixing wall surface facing the first fixing wall surface, and
the angle is between 25° and 85°.

6. The rotor assembly according to claim 1, wherein:
the first helical groove and/or the second helical groove each extends over more than 50% of the axial extension of the fixing area, and
the first helical groove overlaps axially with at least 60% of the second helical groove.

7. The rotor assembly according to claim 1, wherein:
the first helical groove corresponds to a first thread and the second helical groove corresponds to a second thread,
the fixing area comprises at least two thread pitches associated with the first thread and the second thread, and/or
the first thread and/or the second thread has a thread pitch of at least 0.5 mm.

8. The rotor assembly according to claim 1,
wherein the rotor part comprises a plurality of permanent magnets arranged along the circumference, and/or wherein the rotor part comprises a rotor core including a plurality of metal sheet sections stacked axially,
wherein at least some of metal sheet sections includes retaining sections distributed circumferentially around the rotor part, and
wherein the permanent magnets are positioned along the circumference on the holding sections, wherein the plastic section surrounds the metal sheet sections and the permanent magnets.

9. A pump device, comprising
a rotor assembly according to claim 1;
at least one pump rotor configured to convey a fluid from an inlet to an outlet;
wherein a drive device includes the rotor assembly for driving the pump rotor,
wherein the rotor assembly serves as a drive rotor of the drive device,
wherein the pump rotor is fixedly connected to the shaft of the rotor assembly, and
wherein the shaft is rotatably disposed between the pump rotor and the drive rotor about an axially extending axis of rotation.

10. A shaft for a rotor assembly, comprising:
a hollow shaft body having a fixing area configured to receive a rotor part secured by a plastic section,
wherein the fixing area includes at least a first fixing projection and a second fixing projection, each configured to engage behind the rotor part to provide positional fixation on the shaft via the plastic section, and
wherein the fixing area further includes at least a first helical groove and a second helical groove, the first and second helical grooves intersecting to define the plurality of fixing projections.

11. A method for manufacturing a shaft, the method comprising:
providing a hollow shaft having a fixing area, the fixing area having a substantially constant outer diameter;
forming a first helical groove in the fixing area, wherein the first helical groove is right-handed; and
forming a second helical groove in the fixing area such that the first helical groove intersects the second helical groove, thereby defining fixing projections in the fixing area,
wherein the second helical groove is left-handed, and
wherein the first and/or second helical grooves are cut into the hollow shaft.

12. The rotor assembly according to claim 2, wherein the hollow shaft comprises:
a first wall thickness extending radially between the shaft passage and one of the first and second fixing projections;
a second wall thickness extending radially between the shaft passage and the fixing recess,
wherein the second wall thickness is at most 50% of the first wall thickness.

13. The rotor assembly according to claim 2, wherein the hollow shaft comprises:
a first wall thickness extending radially between the shaft passage and one of the first and second fixing projections; and
a second wall thickness extending radially between the shaft passage and the fixing recess,
wherein the second wall thickness is at most 35% of the first wall thickness.

14. The rotor assembly according to claim 1, wherein:
the first and second fixing projections are radially tapered such that an angle is defined between a first fixing wall surface of the first fixing projection and a second fixing wall surface of the second fixing projection, the second fixing wall surface facing the first fixing wall surface, and
the angle is at least 45°.

15. The rotor assembly according to claim 2, wherein:
the first and second fixing projections are produced by machining including cutting the first helical groove and/or the second helical groove, and
the hollow shaft has a substantially constant wall thickness prior to cutting the respective helical groove.

16. The rotor assembly according to claim 3, wherein:
the first and second fixing projections are produced by machining including cutting the first helical groove and/or the second helical groove, and
the hollow shaft has a substantially constant wall thickness prior to cutting the respective helical groove.

17. The rotor assembly according to claim 2, wherein:
the first and second fixing projections are radially tapered such that an angle is defined between a first fixing wall surface of the first fixing projection and a second fixing wall surface of the second fixing projection, the second fixing wall surface facing the first fixing wall surface, and
the angle is between 25° and 85°.

18. The rotor assembly according to claim 3, wherein:
the first and second fixing projections are radially tapered such that an angle is defined between a first fixing wall surface of the first fixing projection and a second fixing wall surface of the second fixing projection, the second fixing wall surface facing the first fixing wall surface, and
the angle is between 25° and 85°.

19. The rotor assembly according to claim 4, wherein:
the first and second fixing projections are radially tapered such that an angle is defined between a first fixing wall surface of the first fixing projection and a second fixing wall surface of the second fixing projection, the second fixing wall surface facing the first fixing wall surface, and
the angle is between 25° and 85°.

20. The pump device according to claim 9, wherein the fluid is lubricant and/or coolant.
